(19) United States
(12) Patent Application Publication
(10) Pub. No.: US 2020/0193074 A1
(43) Pub. Date: Jun. 18, 2020

(54) METHOD OF CONSTRUCTING DYNAMIC SHEAR CONSTITUTIVE MODEL FOR FIBER-REINFORCED COMPOSITE MATERIAL

(71) Applicant: SOUTHEAST UNIVERSITY, Nanjing (CN)

(72) Inventors: Qingguo FEI, Nanjing (CN); Fei GUO, Nanjing (CN); Meng WANG, Nanjing (CN); Peiwei ZHANG, Nanjing (CN); Yanbin LI, Nanjing (CN)

(73) Assignee: SOUTHEAST UNIVERSITY, Nanjing (CN)

(21) Appl. No.: 16/643,600

(22) PCT Filed: Apr. 18, 2018
(86) PCT No.: PCT/CN2018/083482

§ 371 Date: Mar. 2, 2020

(30) Foreign Application Priority Data
Sep. 7, 2017 (CN) 201710800299.2

(51) Int. Cl. G06F 30/23; G06F 30/17; G01N 3/24

(52) U.S. Cl. CPC G06F 30/23; G06F 2113/26; G01N 3/24; G06F 30/17

(57) ABSTRACT

A method of constructing a dynamic shear constitutive model for a fiber-reinforced composite material includes the following steps: 1. carrying out shearing experiments on the fiber-reinforced composite material under a plurality of strain rate loading working conditions to obtain a load-displacement curve under each working condition; 2. combining a Weibull damage model with a viscoelastic model to deduce a load-displacement relationship to be fitted including a Weibull damage distribution; 3. constructing a multi-curve least-squares objective function according to the load-displacement curve and the load-displacement relationship; 4. using a genetic algorithm to obtain initial values of parameters to be fitted, and searching around the obtained initial values of the parameters through a trust-region method to finally obtain a high-precision parameter value and a determined load-displacement relationship including the Weibull damage distribution; and 5. deducing the dynamic shear constitutive model for the composite material including the Weibull damage distribution.

### CROSS REFERENCE TO THE RELATED APPLICATIONS

This application is the national phase entry of International Application No. PCT/CN2018/083482, filed on Apr. 18, 2018, which is based upon and claims priority to Chinese Patent Application No. 201710800299.2, filed on Sep. 7, 2017, the entire contents of which are incorporated herein by reference.

### TECHNICAL FIELD

The present disclosure belongs to the technical field of research on mechanical properties of composite materials, and more particularly relates to a method of constructing a dynamic shear constitutive model for a fiber-reinforced composite material.

### BACKGROUND

Composite materials are widely used in the aerospace field, and aircraft structures have long been used in dynamic loading environments. According to research, it is indicated that composite materials have obvious strain rate effects, that is, the strength and stiffness of materials change with the change of strain rate. Therefore, studying the mechanical properties of composite materials under dynamic loading conditions is particularly important for the design of aircraft structures. Meanwhile, the dynamic constitutive model for composite materials is also an important prerequisite for finite element simulation.

There are currently two methods for establishing a dynamic constitutive model. The first method is to fit a Johnson-Cook dynamic constitutive model according to experimental data at different strain rates of the material, but the constitutive model is mainly applied to describe the dynamic constitutive relationship of metal materials. The second method is to combine a damage model with a strain rate hardening term to deduce a dynamic constitutive model, and fit the constitutive model through experimental data at different strain rates of the material, which can be applied to the establishment of the dynamic constitutive model for composite materials. Mingshuang Liu (Mingshuang L, Yulong L, Fei X, et al. Dynamic compressive mechanical properties and a new constitutive model of 2D-C-SiC composites [J]. Materials Science and Engineering: A, 2008, 489(1):120-126.) discloses a method of constructing a dynamic constitutive model for a C-SiC composite material, which uses the Weibull damage distribution to characterize a progressive damage process of the material during loading and uses a strain rate dependent relevant term (an elastic parameter) to characterize the strain rate hardening of the material, respectively. However, the strain rate hardening term is only determined according to the approximate law of several sets of experimental data obtained, and does not give specific physical meanings, which has greater empiricality and therefore does not have generalization. Shen Lingyan (Shen Lingyan, Li Yongchi, Wang Zhihai, et al. Experimental and theoretical research on dynamic mechanical properties of 3D orthogonal woven glass fiber-epoxy resin composites [J]. Chinese Journal of Composites, 2012, 29(4): 157-162.) discloses a method of constructing a dynamic constitutive model for a glass fiber-epoxy resin composite material, which uses a bi-power form containing a strain rate to characterize a damage accumulation amount of the material and uses a Zhu-Wang-Tang nonlinear viscoelastic model to characterize a strain rate hardening effect of the material, respectively. However, the description of the choice of the damage accumulation amount D in the article is to “tentatively take it as a bi-power form”, which has greater empiricality, and also does not have generalization in the method of constructing the dynamic constitutive model.

In order to obtain the dynamic constitutive relationship of the composite material, loading tests at a plurality of speeds need to be completed, and the parameters of each loading curve can be obtained by a parameter fitting method. At present, parameter fitting is mainly directed to fitting of a single curve, and the fitting method for multiple curves in which some parameters in the curves are commonly used is not perfect. Meanwhile, in the multi-parameter fitting process, it faces the problems such as a slow convergence speed, sensitive dependence on initial value, and prone to local convergence.

### SUMMARY

Objective of the invention: in view of the problems existing in the prior art, the present invention provides a method of constructing a dynamic shear constitutive model including a Weibull damage distribution for a fiber-reinforced composite material, wherein the uniqueness and accuracy of the constitutive model are ensured, and a parameter fitting method combining a genetic algorithm with a trust-region method can provide a reliable basis for a numerical simulation calculation of the fiber-reinforced composite material under dynamic working conditions.

Technical solution: in order to solve the above technical problems, the present invention provides a method of constructing a dynamic shear constitutive model for a fiber-reinforced composite material, including the following steps:

1) carrying out shearing experiments on the fiber-reinforced composite material under a plurality of strain rate loading cases to obtain load-displacement curves under different strain rate loading cases;

2) combining a Weibull damage model with a viscoelastic model to deduce a load-displacement relationship to be fitted including a Weibull damage distribution;

3) constructing a multi-curve least squares objective function according to the load-displacement curve (experimental curve) obtained in step 1 and the load-displacement relationship (theoretical curve) obtained in step 2;

4) using a genetic algorithm to obtain initial values of parameters to be fitted, and carrying out searching around the obtained initial values of the parameters through a trust-region method to finally obtain high-precision values of the parameters and a determined load-displacement relationship including the Weibull damage distribution; and
5) deducing the dynamic shear constitutive model for the composite material including the Weibull damage distribution according to a load-stress relationship, a displacement-strain relationship, and the load-displacement relationship obtained in step 4.

Further, specific steps of obtaining the load-displacement curve under each working condition in step 1 are as follows: first of all, a cylindrical composite material specimen is adopted to perform a quasi-static shear experiment and dynamic shear experiments at a plurality of strain rates, wherein the quasi-static experiment is performed on a universal testing machine, and the dynamic experiments are performed on a dynamic test system such as a drop weight impact test system; and the load-displacement curves are recorded during the experiments.

Further, specific steps of combining the Weibull damage model with the viscoelastic model to deduce the load-displacement relationship to be fitted including the Weibull damage distribution in step 2 are as follows: the Weibull damage distribution is used to characterize a damage evolution process of the composite material during loading, and the viscoelastic model is used to characterize a strain rate hardening effect of the composite material under the dynamic loading working condition; and the damage model and the viscoelastic model are combined to characterize the load-displacement relationship of the composite material under a dynamic shear loading, wherein, a strain rate hardening factor k_{d}, a damage accumulation amount D and the load-displacement relationship are expressed as follows, respectively:

$${k}_{d} = {k}_{2} x + ϕ \dot{γ} ( 1 - {e}^{- \frac{{k}_{1} x}{ϕ \dot{γ}}} ) , \\ D = 1 - {e}^{- {( x / a )}^{b}} , \\ F = {e}^{- {( x / a )}^{b}} [ {k}_{2} x + ϕ \dot{γ} ( 1 - {e}^{- \frac{{k}_{1} x}{ϕ \dot{γ}}} ) ] ,$$

wherein: F is a shear load; x is a shear displacement; e is a natural constant; \dot{γ} is a strain rate, and a value of the \dot{γ} is an average strain rate before reaching an ultimate strength; and parameters a, b, φ, k₁ and k₂ are to be fitted, wherein the parameters b and k₁ are related to the strain rate \dot{γ}.

Further, the viscoelastic model in step 2 adopts a standard linear solid viscoelastic model, and for a mechanical property law of a specific fiber-reinforced composite material under different strain rates, other viscoelastic models can also be used as needed.

Further, the multi-curve least squares objective function constructed by the experimental curve and the theoretical curve in step 3 can be expressed by:

$$E = min ( \frac{1}{m} {\sum }_{i = 1}^{m} \frac{{E}_{i}}{{\overline{c}}_{i}^{2}} ) ,$$

wherein: c̅ᵢ is a load average value of the load-displacement curve at an i^{th} loading speed, and m is a number of load-displacement curves to be fitted;

wherein Eᵢ is a weighted residual sum of squares between experimental values and fitted values of the load-displacement curve at the i^{th} loading speed, and is expressed by:

$${E}_{i} = \frac{1}{n} {\sum }_{k = 1}^{n} {[ {\hat{F}}_{i} ( k ) - {F}_{i} ( k ) ]}^{2} ;$$

wherein: \hat{F}ᵢ(k) and \hat{F}ᵢ(k) are a measured load value of an i^{th} experiment and a corresponding fitted load value, respectively.

Further, a function of the load-stress relationship and a function of the displacement-strain relationship in step 5 are expressed, respectively, as follows:

$$τ = \frac{2 P}{π {d}^{2}}$$

wherein: τ is a shear stress; P is a shear load; and d is an average diameter of a shear plane of a pin; and

$$γ = arctan ( \frac{x}{δ} ) ,$$

wherein: γ is a shear strain; x is a shear displacement; and δ is a shear band width.

Compared with the prior art, the advantages of the present invention are as follows.

The present invention provides a method for accurately constructing a dynamic shear constitutive model for a fiber-reinforced composite material. The model comprehensively considers the damage accumulation process of the fiber-reinforced composite material during loading and the strain rate hardening effect of the material. The Weibull damage model and the viscoelastic model are combined to construct the dynamic shear constitutive model of the material, which has a clear mechanical meaning. Meanwhile, the experimental data are combined with the genetic algorithm and the trust-region method to fit the parameters in the model, ensuring the uniqueness and accuracy of the constitutive model. The obtained constitutive model can be used for a numerical simulation calculation of the fiber-reinforced composite material under dynamic working conditions.

### BRIEF DESCRIPTION OF THE DRAWINGS

FIG. 1 is an overall flowchart of the present invention.

FIG. 2 is a load-displacement curve recorded in an experiment in an embodiment.

FIG. 3 is a standard linear solid viscoelastic model.

FIG. 4A is a fitting result of a load-displacement curve at quasi-static loading speed in the embodiment.

FIG. 4B is a fitting result of a load-displacement curve at a loading speed of 1 m/s in the embodiment.

FIG. 4C is a fitting result of a load-displacement curve at a loading speed of 5 m/s in the embodiment.

FIG. 4D is a fitting result of a load-displacement curve at a loading speed of 10 m/s in the embodiment.

### DETAILED DESCRIPTION OF THE EMBODIMENTS

The present invention is further described below with reference to the drawings and the specific embodiment.

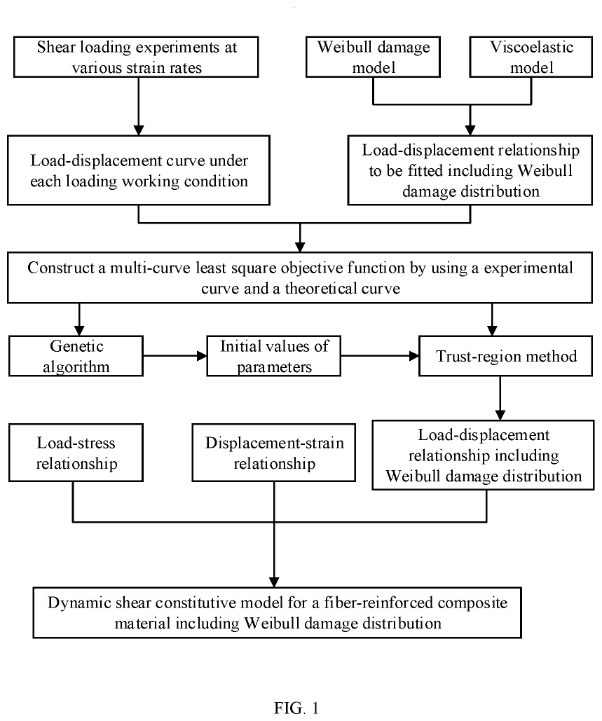

Embodiment: as shown in FIG. 1, a method of constructing a dynamic shear constitutive model for a fiber-reinforced composite material including a Weibull damage distribution includes the following steps.

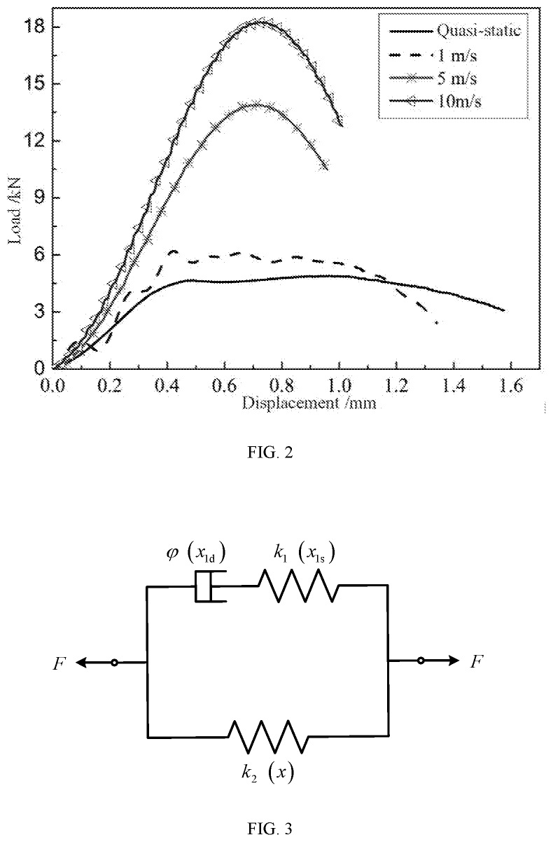

Step 1: the present invention adopts a cylindrical C-C composite material specimen with a diameter of 8.95 mm. On a bolt shear test device, a quasi-static shear experiment is performed through an electronic universal testing machine, and impact shear experiments at different loading speeds (1 m/s, 5 m/s, and 10 m/s) are performed through a drop weight impact test system, and the load-displacement curves during loading are recorded, as shown in FIG. 2.

Step 2: the Weibull damage distribution is used to characterize a damage evolution process of the C-C composite material during loading, a standard linear solid model (shown in FIG. 3) is used to characterize a strain rate hardening effect of the C-C composite material, and the Weibull damage distribution and the standard linear solid model are combined to deduce a load-displacement relationship of the C/C composite material under a dynamic shear loading. A strain rate hardening factor k_{d}, a damage accumulation amount D and the load-displacement relationship are shown in formulas (1), (2), and (3), respectively.

$$\begin{matrix}{k}_{d} = {k}_{2} x + ϕ \dot{γ} ( 1 - {e}^{- \frac{{k}_{1} x}{ϕ \dot{γ}}} ) & ( 1 ) \\ D = 1 - {e}^{- {( x / a )}^{b}} & ( 2 ) \\ F = {e}^{- {( x / a )}^{b}} [ {k}_{2} x + ϕ \dot{γ} ( 1 - {e}^{- \frac{{k}_{1} x}{ϕ \dot{γ}}} ) ] & ( 3 )\end{matrix}$$

wherein: F is a shear load; x is a shear displacement; \dot{γ} is a strain rate, and the value of the \dot{γ} is an average strain rate before reaching the ultimate strength; and parameters a, b, φ, k₁ and k₂ are to be fitted, wherein the parameters b and k₁ are related to the strain rate \dot{γ}.

Step 3: a multi-curve least squares objective function is constructed according to the load-displacement curve obtained from the experiment and a load-displacement curve derived in theory;

$$E = min ( \frac{1}{4} {\sum }_{i = 1}^{4} \frac{{E}_{i}}{{\overline{c}}_{i}^{2}} ) \qquad ( 4 )$$

wherein: c̅ᵢ is a load average value of the load-displacement curve at the i^{th} loading speed; m is the number of load-displacement curves to be fitted; where Eᵢ is a weighted residual sum of squares between experimental values and fitted values of the load-displacement curve at the i^{th} loading speed, and is expressed by:

$${E}_{i} = \frac{1}{n} {\sum }_{k = 1}^{n} {[ {\hat{F}}_{i} ( k ) - {F}_{i} ( k ) ]}^{2} \qquad ( 5 )$$

wherein: \hat{F}ᵢ(k) and \hat{F}ᵢ(k) are a measured load value of the i^{th} experiment and a corresponding fitted load value, respectively.

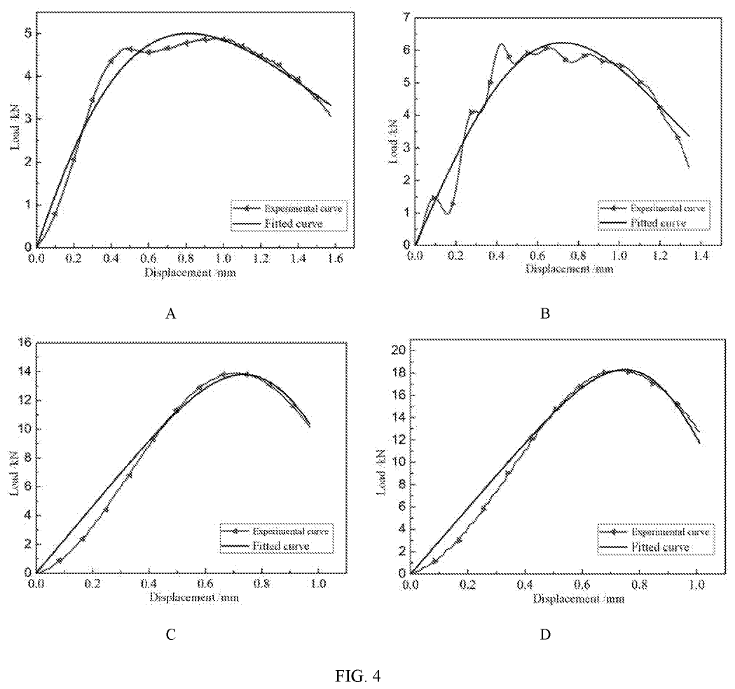

Step 4: a genetic algorithm is adopted to obtain initial values of the parameters to be fitted according to the least squares objective function obtained in step 3, and searching is carried out around the obtained initial values of the parameters through a trust-region method to obtain high-precision values of the parameters to be fitted. The fitting results of the loading curves are as shown in FIG. 4. The parameters b and k₁ obtained by the above fitting under each loading working condition are subjected to a second-order fitting by the least square method, to obtain a function relationship between the parameters b and k₁ and the strain rate \dot{γ}. A load-displacement relationship including the Weibull damage distribution within the range of the strain rate completed in the experiment is finally obtained.

Step 5: According to a load-stress relationship (Formula 6), a displacement-strain relationship (Formula 7) and the obtained load-displacement relationship including the Weibull damage distribution, a constitutive model including the Weibull damage distribution is derived.

$$τ = \frac{2 P}{π {d}^{2}} \qquad ( 6 )$$

wherein: P is a shear load; and d is an average diameter of a shear plane of a pin;

$$γ = arctan ( \frac{x}{δ} ) \qquad ( 7 )$$

wherein: x is a shear displacement; and δ is a shear band width.

The above description is only an embodiment of the present invention, and is not intended to limit the present invention. All equivalent substitutions made within the principles of the present invention shall fall within the protective scope of the present invention. What is not described in detail in the present invention belongs to the existing technology well known to those skilled in the art.

What is claimed is:

1. A method of constructing a dynamic shear constitutive model for a fiber-reinforced composite material, comprising the following steps:
1) carrying out a plurality of shearing experiments on the fiber-reinforced composite material under a plurality of strain rate loading cases to obtain a load-displacement curve under each strain rate loading cases of the plurality of strain rate loading cases;
2) combining a Weibull damage model with a viscoelastic model to deduce a load-displacement relationship to be fitted comprising a Weibull damage distribution;
3) constructing a multi-curve least squares objective function according to the load-displacement curve obtained in step 1) and the load-displacement relationship obtained in step 2), wherein, the load-displacement curve is an experimental curve and the load-displacement relationship is a theoretical curve;
4) using a genetic algorithm to obtain initial values of a plurality of parameters to be fitted, and carrying out searching around the initial values of the plurality of parameters through a trust-region method to finally obtain high-precision values of the plurality of parameters and a determined load-displacement relationship comprising the Weibull damage distribution; and
5) deducing the dynamic shear constitutive model for the fiber-reinforced composite material comprising the Weibull damage distribution according to a load-stress relationship, a displacement-strain relationship, and the determined load-displacement relationship obtained in step 4).

2. The method of constructing the dynamic shear constitutive model for the fiber-reinforced composite material according to claim 1, wherein, specific steps of obtaining the load-displacement curve under the each strain rate loading working condition in step 1) are as follows: first of all, a cylindrical composite material specimen is adopted to perform a quasi-static shear experiment and a plurality of dynamic shear experiments at a plurality of strain rates, wherein the quasi-static experiment is performed on a universal testing machine, and the plurality of dynamic shear experiments are performed on a dynamic test system, the dynamic test system is a drop weight impact test system; and then the load-displacement curve is recorded during each experiment of the quasi-static shear experiment and the plurality of dynamic shear experiments.

3. The method of constructing the dynamic shear constitutive model for the fiber-reinforced composite material according to claim 1, wherein, specific steps of combining the Weibull damage model with the viscoelastic model to deduce the load-displacement relationship to be fitted comprising the Weibull damage distribution in step 2) are as follows: the Weibull damage distribution is configured to characterize a damage evolution process of the fiber-reinforced composite material during loading, and the viscoelastic model is configured to characterize a strain rate hardening effect of the fiber-reinforced composite material under a dynamic loading working condition; and the Weibull damage model and the viscoelastic model are combined to characterize the load-displacement relationship of the fiber-reinforced composite material under a dynamic shear loading, wherein, a strain rate strengthening factor k_{d}, a damage accumulation amount D and the load-displacement relationship are expressed as follows, respectively:
$${k}_{d} = {k}_{2} x + ϕ \dot{γ} ( 1 - {e}^{- \frac{{k}_{1} x}{ϕ \dot{γ}}} ) , \\ D = 1 - {e}^{- {( x / a )}^{b}} , \\ F = {e}^{- {( x / a )}^{b}} [ {k}_{2} x + ϕ \dot{γ} ( 1 - {e}^{- \frac{{k}_{1} x}{ϕ \dot{γ}}} ) ] ,$$
wherein: F is a shear load; x is a shear displacement; e is a natural constant; \dot{γ} is a strain rate, and a value of the \dot{γ} is an average strain rate before reaching an ultimate strength; and the plurality of parameters to be fitted comprises a, b, φ, k₁ and k₂, wherein the b and the k₁ are related to the strain rate \dot{γ}.

4. The method of constructing the dynamic shear constitutive model for the fiber-reinforced composite material according to claim 1, wherein, the viscoelastic model in step 2) adopts a standard linear solid viscoelastic model.

5. The method of constructing the dynamic shear constitutive model for the fiber-reinforced composite material according to claim 1, wherein, the multi-curve least squares objective function constructed by the experimental curve and the theoretical curve in step 3) is expressed by:
$$E = min ( \frac{1}{m} {\sum }_{i = 1}^{m} \frac{{E}_{i}}{{\overline{c}}_{i}^{2}} ) ,$$
wherein: c̅ᵢ is a load average value of the load-displacement curve at an i^{th} loading speed, and m is a number of a plurality of load-displacement curves to be fitted;
wherein Eᵢ is a weighted residual sum of squares between a plurality of experimental values of the load-displacement curve at the i^{th} loading speed and a plurality of fitted values of the load-displacement curve at the i^{th} loading speed, and is expressed by:
$${E}_{i} = \frac{1}{n} {\sum }_{k = 1}^{n} {[ {\hat{F}}_{i} ( k ) - {F}_{i} ( k ) ]}^{2} ;$$
wherein: \hat{F}ᵢ(k) is a measured load value of an i^{th} experiment, and \hat{F}ᵢ(k) is a fitted load value corresponding to the measured load value of the i^{th} experiment.

6. The method of constructing the dynamic shear constitutive model for the fiber-reinforced composite material according to claim 1, wherein, a function of the load-stress relationship and a function of the displacement-strain relationship in step 5) are expressed, respectively, as follows:
$$τ = \frac{2 P}{π {d}^{2}} ,$$
wherein: τ is a shear stress; P is a shear load; and d is an average diameter of a shear plane of a pin; and
$$γ = arctan ( \frac{x}{δ} ) ,$$
wherein: γ is a shear strain; x is a shear displacement; and δ is a shear band width.
